(19) United States
(12) Patent Application Publication
(10) Pub. No.: US 2004/0172064 A1
(43) Pub. Date: Sep. 2, 2004

(54) Treatment table with an aroma dispenser

(76) Inventor: Bonnie MacDonald, Plano, TX (US)

Correspondence Address: ROBINSON & POST, L.L.P., NORTH DALLAS BANK TOWER, SUITE 575, 12900 PRESTON ROAD, LB-41, DALLAS, TX, 75230, US

(21) Appl. No.: 10/377,203

(22) Filed: Feb. 27, 2003

(51) Int. Cl. A61H 1/00; A47C 20/00

(52) U.S. Cl. 606/240; 5/725; 5/641; 601/15; 128/845

(57) ABSTRACT

A treatment table has a raised surface portioned to receive a person desiring treatment. The raised surface has an associated face position, either included in the surface or a face rest removably attached to the table for receiving the person's face when the person desiring treatment lays on their stomach on the raised surface. The face position having an opening to facilitate unobstructed breathing. An aroma dispenser is positioned near the opening so that the aroma given off by the dispenser may be inhaled by the person desiring treatment.

### BACKGROUND OF THE INVENTION

This invention relates to a treatment table and in particular a treatment table used by a massage therapist and further a treatment table with an aroma dispenser.

When a patient or client lays down on a treatment table for receiving treatment, fluids in the body tend to flow into the patient's sinuses. This problem is enhanced when the patient or client is receiving a massage. A skilled massage therapist by applying pressure to the back of the legs, buttocks and back will force fluids up into the patients head and into the sinuses. This will cause what should be a relaxing and enjoyable experience to become very uncomfortable. In order to avoid this problem, a skilled therapist will place a drop of aroma fluid such as peppermint, eucalyptus, menthol or lavender under the patient's nose or include a aerosol dispenser such as a vaporizer in the treatment room. This of course can cause discomfort to the patient from the liquid placed on the upper lip or to the therapist for having to breath the dispensed vapors all day.

### SUMMARY OF INVENTION

A treatment table has a raised surface portioned to receive a person desiring treatment. The raised surface has an associated face position either included in the surface or a face rest removably attached to the table for receiving the person's face when the person desiring treatment lays on their stomach on the raised surface. The face position having an opening to facilitate breathing. An aroma dispenser is positioned near the opening so that the aromas given off by the dispenser may be inhaled by the person desiring the treatment.

In one embodiment the aroma dispenser is a cage of wire mesh with a connector such a blade for inserting between a padded top surface and a hard bottom surface of the face rest of treatment surface or an alligator clip that clips to the hard surface. The cage is connected to the connector with as link that can be 3 to 5 inches of a chain, plastic strap or cloth ribbon. The cage has two sides that are hinged together and includes a latch that latches the two sides together. Thus, the cage can be opened for inserting a piece of absorbing material such a cotton ball are a small sponge containing a charge of aroma fluid. After treatment the absorbing material may then be removed and discarded.

In an alternate embodiment the aroma dispenser is a plastic box having spaced holes and two sides that are hinged together with a hinged and a latch holds the two sides together. The plastic box may be connected to the face rest or treatment surface with the articles discussed in conjunction with the wire mesh cage above.

Another embodiment of the aroma dispenser a surgical sponge at the end link that can be 3 to 5 inches of a chain, plastic strap or cloth ribbon. The link has a connector on the other end and can be a device such as a blade for inserting between the padded top surface and the padded and hard bottom surface or alternatively an alligator clip. This embodiment has the advantage of being disposable when the aroma runs out.

In a more holistic embodiment the aroma dispenser is shaped like a cupped hand. The cupped hand is balanced in a stirrup and is positioned to received a cotton ball or a small sponge. The stirrup is connected to a link which has a connector on the end opposite the link and is placed near the opening of the face position or face rest.

### BRIEF DESCRIPTION OF THE FIGURES

FIG. 1 illustrates a treatment table having an aerosol dispenser associated therewith;

FIG. 2 shows a headrest with an attached aroma dispenser;

FIG. 3 shows an embodiment of the aroma dispenser of FIGS. 1 and 2;

FIG. 4 is a second embodiment of an aroma dispenser of FIGS. 1 and 2, showing the dispenser in an open position;

FIG. 5 provides one device for attaching the aroma dispenser to the treatment table of FIG. 1;

FIG. 6 shows an alternate attachment device for attaching the aroma dispenser of FIGS. 3, 4, 7 and 8 to the treatment table of FIG. 1;

FIG. 7 is another alternate embodiment of an aroma dispenser;

FIG. 8 is yet another embodiment of an aroma dispenser;

FIG. 9 is yet another embodiment of an aroma dispenser; and

FIG. 10 is an alternate embodiment of the massage table according to the invention.

### DETAILED DESCRIPTION OF THE EMBODIMENTS

Referring to FIG. 1 there is shown a treatment table 10 such as that used by massage therapists. A patient 2 will lay on his stomach on the surface 1 of the treatment table 10. In the embodiment of FIG. 1, the treatment table is portable and has four legs 3 with foldable braces 5 and stiffeners 7. There is a removable face rest 9 that has an aroma dispenser 15 attached to it. In the embodiment of FIG. 1 the face rest 9 is detachable. However, there are massage tables where there is an opening at the face position, where the patient will lay flat on the table placing his head over the opening that extends through the table and this will facilitate breathing of the patient.

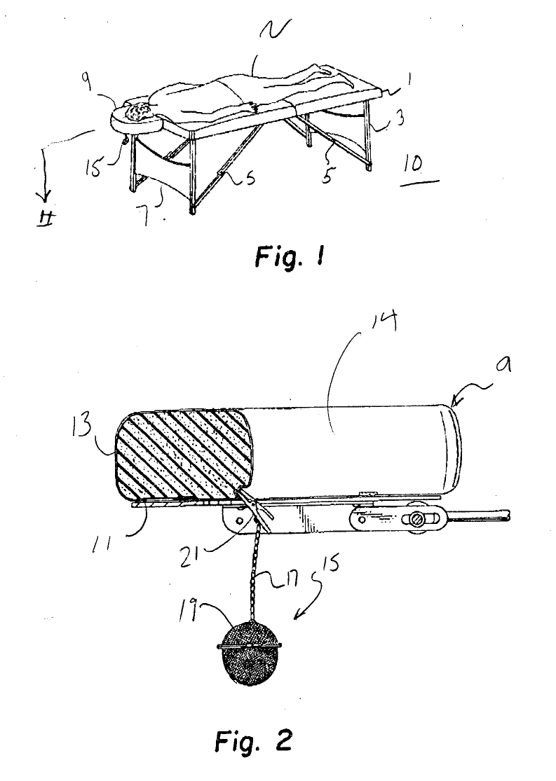

FIG. 2 is a sectional view of the face rest 9. The face rest includes: a hard surface 11 on which is mounted a cushion surface 13 and there is an opening 14 where the mouth and nose would be positioned to facilitates unobstructed breathing of the patient. There is an aroma dispenser 15 that includes a wire mesh cage 19 and a link 17 made up of a small chan that is connected to an alligator clip 21. The link 17 needs to be positioned and long enough so that the therapist can easily reach under the table to release it, and yet positioned at a distance away from the opening 14 so that the aroma given off by the aroma fluids may rise and be inhaled by the patient.

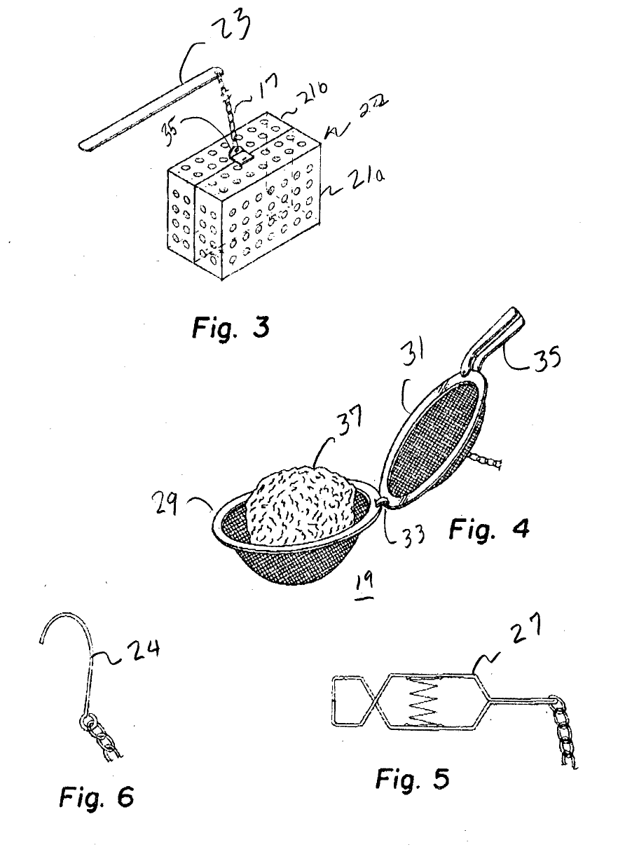

Referring to FIG. 3, there is shown an alternate embodiment of the aroma dispenser. That includes a box 22 that has a first side 22a and a second 22b. The box two sides are hinged in a similar manner as the embodiment of FIG. 2, although the hinge is not shown in the view, and held in the closed position by a latch 35. There is a link 17 connected to a blade 23. The blade facilitates the connecting of the dispenser 22 to the head rest by being able to slide between the cushion pad 13 and the hard frame 11.

FIG. 4 is another embodiment of dispenser 15 of FIG. 2 which includes a first side 29 and a second side 31. The two sides are held together by a hinge 22. The dispenser 19 may be opened and a piece of cotton 37 inserted, usually the cotton will have absorbed some aroma fluid such as peppermint, eucalyptus, menthol or lavender. The side 31 may be closed and a latch 35 closed to hold the side 31 to the side 29. When the treatment is completed, dispenser 19 may be opened and the cotton ball discarded.

FIG. 5 is a heavy duty alligator or battery clip 27 is shown which also may be used. It includes a link 17 which is connected at the other end to a dispenser.

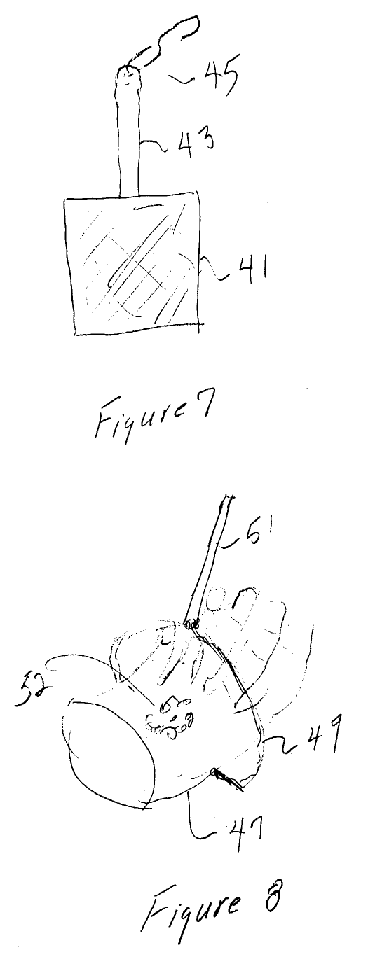

FIG. 6 shows a different method of connecting the dispenser to either the face rest 9 or to the table 1. It consists of a hook 24 that is connected to the link 17.

Referring to FIG. 7, there is shown a disposable embodiment of the invention and it includes a surgical sponge 41 which typically would be approximately a two inch square. The surgical sponge is connected to a straightened paper clip 45 by a cloth ribbon 43. It is anticipated that the surgical sponge could be manufactured with the aroma fluid inserted and then sealed in an airtight pouch until ready for use.

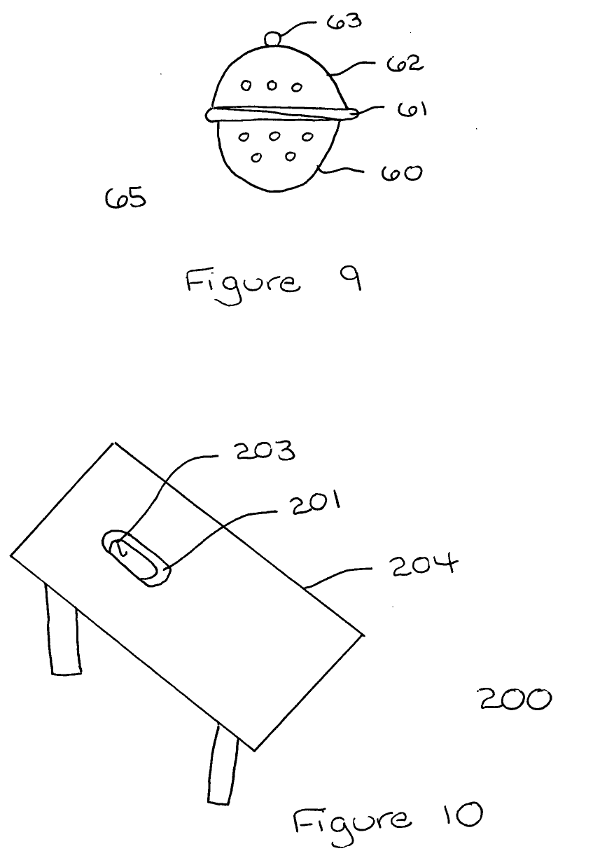

FIG. 8 provides a more holistic type of aroma dispenser and it includes a molded cupped hand 47. The hand is balanced in a stirrup 49 where it can receive an aroma charged cotton ball or sponge. The stirrup is connected to a plastic strap 51 on one end and the other end is connected to one of the connectors of FIG. 3, 5, or 6 for attaching to the treatment table.

FIG. 9 is yet another embodiment of the aroma dispenser 65 having a top section 62 and a bottom section 60. Each section is threaded by treads 61 to facilitate their separation so that an aroma charged cotton ball or sponge may be placed within the lower section 60 which is attached to the top section screwing the bottom section 60 into the top section 62. An eyelet 63 is provided for attachment of a link and connector.

FIG. 10 shows a massage table 200 that includes a padded surface 204. A face position is located generally around the opening 201 that includes a hook 203 for attaching an aroma dispenser such as those previously discussed.

1. A treatment table comprising:
a raised surface portioned to received a person desiring treatment;
the raised surface includes a face position for receiving the person's face when the person desiring treatment lays on their stomach on the raised flat surface, the face position having an opening to facilitate breathing; and
an aroma dispenser located near the opening.

2. The treatment table according to claim 1 wherein the aroma dispenser includes: a connector for connecting the dispenser to the raised surface near the opening and a link means for linking the cage to the connector.

3. The treatment table according to claim 1 wherein the aroma dispenser comprises a cage includes a first side and a second side, a hinge positioned to connect the first side to the second side and a latch for latching the first and second sides together.

4. The treatment table according to claim 2 wherein the raised surface includes a firm first surface on which is located a padded second surface and the connector includes a blade for inserting between the firm first surface and the padded second surface.

5. The treatment table according to claim 2 wherein the raised surface includes a firm first surface on which is located a padded second surface and the connector comprises a member of a group that includes a hook, alligator clip, battery clip, a straightened paper clip and fasteners for attaching to the hard surface.

6. The treatment table according to claim 2 wherein the link comprise a member of a group that includes a chain, plastic strap or cloth ribbon.

7. The treatment table according to claim 1 wherein the aroma dispenser comprises: a plastic box having spaced holes and a connector for connecting the dispenser to the raised surface near the opening and a link means for linking the box to the connector.

8. The treatment table according to claim 1 wherein the aroma dispenser comprises: a surgical sponge and a connector for connecting the dispenser to the raised surface near the opening and a link means for linking the sponge to the connector.

9. The treatment table according to claim 1 wherein the aroma dispenser comprises: a sculpture of a cupped hand having a stirrup connected to the cupped hand to hold it in a balance positioned and a connector for connecting the dispenser to the raised surface near the opening and a link means for linking the stirrup to the connector.

10. The treatment table according to claim 1 wherein the aroma dispenser comprises a container having a plurality of spaced holes and a first half with a first threaded opening and a second half having a second threaded opening that is mateable to the first threaded opening.

11. A treatment table comprising:
a raised surface portioned to received a person desiring treatment;
a face rest attachable to the raised surface, the rest being position for receiving the person's face when the person desiring treatment lays on their stomach on the raised flat surface, the face position having an opening to facilitate breathing; and
an aroma dispenser located near the opening.

12. The treatment table according to claim 11 wherein the aroma dispenser includes a connector for connecting the dispenser to the face rest near the opening and a link means for linking the cage to the connector.

13. The treatment table according to claim 11 wherein the aroma dispenser comprises a cage includes a first side and a second side, a hinge positioned to connect the first side to the second side and a latch for latching the first and second sides together.

14. The treatment table according to claim 11 wherein the face rest includes a firm first surface on which is located a padded second surface and the connector includes a blade for inserting between the firm first surface and the padded second surface.

15. The treatment table according to claim 11 wherein the face rest includes a firm first surface on which is located a padded second surface and the connector includes an alligator clip for clipping to the hard surface.

16. The treatment table according to claim 11 wherein the link comprise a member of a group that includes a chain, plastic strap or cloth ribbon.

17. The treatment table according to claim 11 wherein the aroma dispenser comprises a plastic box having spaced holes and a connector for connecting the dispenser to the face rest near the opening and a link means for linking the box to the connector.

18. The treatment table according to claim 11 wherein the aroma dispenser comprises a surgical sponge and a connector for connecting the dispenser to the face rest near the opening and a link means for linking the sponge to the connector.

19. The treatment table according to claim 11 wherein the aroma dispenser comprises: a sculpture of a cupped hand having a stirrup connected to the cupped hand to hold it in a balance positioned and a connector for connecting the dispenser to the raised surface near the opening and a link means for linking the stirrup to the connector.

20. The treatment table according to claim 11 wherein the aroma dispenser comprises a container having a plurality of spaced holes and a first half with a first threaded opening and a second half having a second threaded opening that is mateable to the first threaded opening.
